(19) United States
(12) Patent Application Publication
(10) Pub. No.: US 2011/0087482 A1
(43) Pub. Date: Apr. 14, 2011

(54) Method for identifying and manipulating language information

(76) Inventor: Frank John Williams, Los Alamitos, CA (US)

(21) Appl. No.: 12/587,937

(22) Filed: Oct. 14, 2009

(51) Int. Cl. G06F 17/27

(52) U.S. Cl. 704/9

(57) ABSTRACT

A preferred method and methods for manipulating linguistic information in grammatical disarray are disclosed. In a preferred method, a plurality of word elements in sequential order from a data corpus are analyzed with a conceptual-grammatical relational protocol such as CIRN producing an unsuccessful outcome; wherein said unsuccessful outcome involves the failure of forming an association or failure of identifying an association between said word elements. Then, the word elements are shuffled, forming different sequential orders to later be reanalyzed with same or other conceptual-grammatical relational protocols until a successful outcome is attained; wherein a successful outcome includes at least one of a: association between said word elements, and identification of an association between said word elements.

### RELATED APPLICATIONS

This is application claims the benefit of: U.S. provisional patent application Ser. No. 61/124,516, filed 2008 Oct. 14 by the present inventor.

### BACKGROUND

1. Field of Invention

The present invention relates to a method for manipulating information. More particularly, a novel method of identifying nonsensical data and modifying its original sequential order for identifying a more conceptually and/or grammatical suitable sequential order, thus allowing information applications to automatically or optionally correct data miss-entry.

2. Description of Related Art

The Revolution of the computer and the Internet are responsible for a series of innovations, applications and software such as speech recognition software, word processing, search engines and many others which have become an integral part of people's lives. Accordingly, data entry has become a common, imperative and central part in the communication between man and machine. However, the current inability of machines and software to effectively understand human language, has encouraged and/or endorsed among many of their users to simply submit entry words in an almost random sequence, thus disrespecting their contextual order, sense and grammar; which in return, enhances and promotes the formation of irrelevance, while permitting the misunderstanding of commands to machines, thus departing user's and machines from better communications. For example, in a search engine, a user wanting to retrieve records involving “the house is red” may simply enter “house red.” Consequentially, the query is now grammatically and/or contextually compromised, which in return promotes the undesired search behavior of simply retrieving any documents that comprise the query's words in any particular order, therefore resulting in large amounts of documents and increased user's effort and time needed to discriminate between good and bad data. A further example involves an application such as speech recognition, wherein a user in hasten may unconsciously alternate the sequence of words of a spoken command to a central home-management system per se, such as saying “my cell phone is where?” instead of “where is my cell phone;” thus resulting in a mismatch of the sequential word protocols (proper grammar) that is need to identify or understand the said command.

In view of the present shortcomings, the present invention distinguishes over the prior art by providing heretofore a method for identifying grammatically improper or compromised data, thus allowing information systems and applications to manage said data in a more fulfilling and compelling manner, to enable users and machines to communicate less effortlessly and/or with lesser grammatical restrictions, while providing additional unknown, unsolved and unrecognized advantages as described in the following summary.

### SUMMARY OF THE INVENTION

The present invention teaches certain benefits in use and construction which give rise to the objectives and advantages described below. The methods and systems embodied by the present invention overcome the limitations and shortcomings encountered when entering non-grammatical or nonsensical information. The method(s) permit to modify said non-grammatical or nonsensical data for identifying a more suitable conceptual and/or grammatical configuration, further avoiding the generation of conceptually irrelevance, erroneous and more nonsensical data.

### OBJECTS AND ADVANTAGES

A primary objective inherent in the above described methods of use is to provide several methods and systems to manipulate nonsensical information by allowing the systems or systems using said disclosed methodologies the ability of identifying senseless or unusable information and producing or generating useful or prospectively functional data not taught by the prior arts and further advantages and objectives not taught by the prior art. Accordingly, several objects and advantages of the invention are:
Another objective is to avoid the generation of irrelevant and nonsense data during searching.
Another objective is to save user time by providing only conceptually matching data.

A further objective is to decrease the amount of effort implemented by users discriminating for irrelevant and nonsense data.

A further objective is to decrease the amount of effort implemented by users searching for relevant data.

A further objective is to improve the quality and quantity of results.

A further objective is to permit machines and programs to handle language more efficiently.

A further objective is to improve the ability of devices and portable devices to manipulate language information.

Another further objective is to permit the unification of the world's knowledge regardless of language and/or grammar.

Another objective is to permit grammatical flexibility in machine-man communications.

Another objective is to permit the inferring of intended meanings and information from non-grammatical data.

Other features and advantages of the described methods of use will become apparent from the following more detailed description, taken in conjunction with the accompanying drawings which illustrate, by way of example, the principles of the presently described apparatus and method of its use.

### BRIEF DESCRIPTION OF THE DRAWINGS

The accompanying drawings illustrate examples of at least one of the best mode embodiments of the present method and methods of use. In such drawings:

FIG. 1 illustrates an exemplary non-limiting flow chart diagram of some steps of the inventive method for identifying a suggestion or a resolve of a data corpus;

FIG. 2A is a non-limiting exemplary block diagram of the inventive method handling an exemplary Data Corpus such as “house red;”

FIG. 2B is a non-limiting exemplary block diagram of the inventive method handling an exemplary Data Corpus such as “house red” while implementing other word elements such as grammatical eeggi;

FIG. 2C is a non-limiting exemplary block diagram of the inventive method handling an exemplary Data Corpus such as “house the red” while implementing other word elements such as numeric spectrum identifier or eeggi;

### DETAILED DESCRIPTION

The above described drawing figures illustrate the described methods and use in at least one of its preferred, best mode embodiment, which are further defined in detail in the following description. Those having ordinary skill in the art may be able to make alterations and modifications from what is described herein without departing from its spirit and scope. Therefore, it must be understood that what is illustrated is set forth only for the purposes of example and that it should not be taken as a limitation in the scope of the present system and method of use.

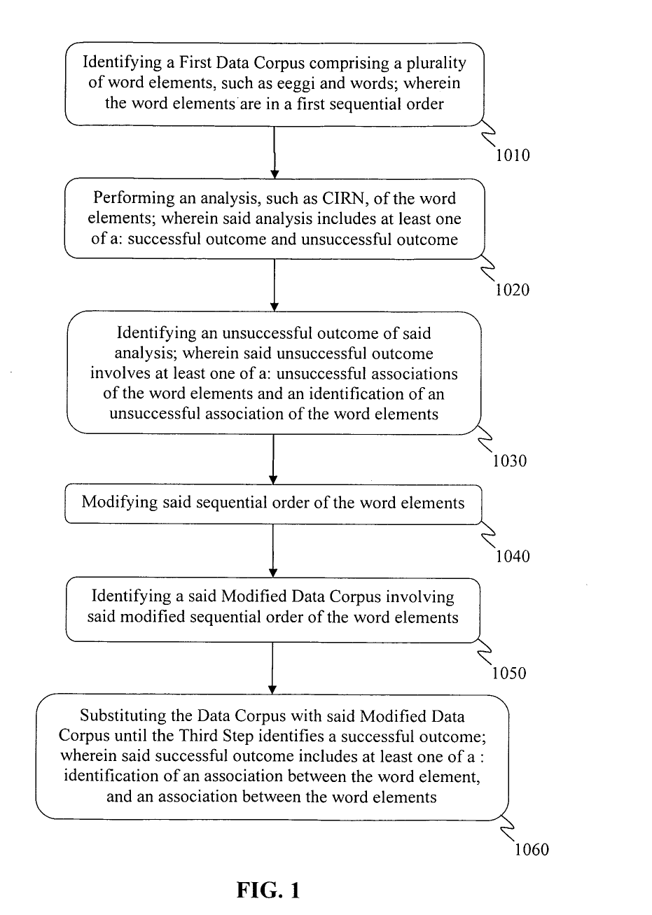

FIG. 1 illustrates an exemplary non-limiting flow chart diagram of some steps of the inventive method for identifying a suggestion or a resolve of a data corpus. The First Step 1010 (FIG. 1) involves the step of identifying a Data Corpus comprising a plurality of word elements (information identifying words, such as text, group identifiers, eeggi, sounds, etc.); wherein said word elements inherently comprise an input or natural sequential order. For example, a query such as “the house is blue” comprises several word elements (or words in this example) inherently involving a sequential order; wherein “the” is obviously the first element, “house” is next, then “is” and finally “blue.” The next or Second Step 1020 (FIG. 1) involves the procedure of analyzing the said Data Corpus; wherein said analysis, like CIRN, intends to identify a conceptual and/or grammatical relation or association between the word elements of the Data Corpus, hopefully resulting in an association (successful outcome) or none (unsuccessful outcome). For example, when a Data Corpus like “pretty Mary” is analyzed by a conceptual and/or grammatical relational analysis, such as CIRN, the analysis identifies and/or forms an association between the word “pretty” and the word “Mary” because, given their sequential order, the adjective (pretty) is before the noun (Mary), thus resulting in a successful analysis or outcome. On contrary, another query such as “Mary pretty” forms no associations since the adjective (pretty) is after the noun (Mary), thus resulting on an unsuccessful outcome (no associations). The next or Third Step 1030 (FIG. 1) involves the step of identifying an unsuccessful outcome; wherein said unsuccessful outcome involves the failure of forming or identifying the possibility of forming an association between the analyzed word elements. The Fourth Step 1040 (FIG. 1) involves the procedure of modifying the sequential order, or in more lame terms, shuffling the array or location of the word elements with respect to each other. For example, one of the exemplary queries mentioned in the Second Step was “Mary pretty,” which according to the Third Step implied no associations. Accordingly, “shuffling” or modifying said sequential order entails to change their sequential order to “pretty Mary” per se (Mary which was first, is now second and “pretty” which was second, is now first). The Fifth Step 1050 (FIG. 1) involves the obvious or sub-sequent step of identifying the newly formed data corpus (new sequential order of words) involving the newly assumed positions or newly attained sequential order resulting from said shuffling of the word elements. The next or Sixth Step 1060 (FIG. 1) involves the step of substituting or replacing the Data Corpus with the Newly Formed Data Corpus (even modifying the Data Corpus to resemble the Newly Formed Data Corpus) and to continue with another same type analysis (CIRN or the alike) until a successful association or identification of a successful association is hopefully attained. In other words, the process of identifying an unsuccessful analysis and thus shuffling of the word elements to be re-analyzed, will continue until a new sequential order or array of the word elements produces a successful outcome (forming an association or identifying an association). In such fashion the original order of elements continues to be shuffled until a new order hopefully produces a successful outcome or association. Noteworthy, the term “hopefully is being used” with the intension of implying an end to the process. In other words, shuffling may occur several times, but will end once all elements have occupied every possible array available.

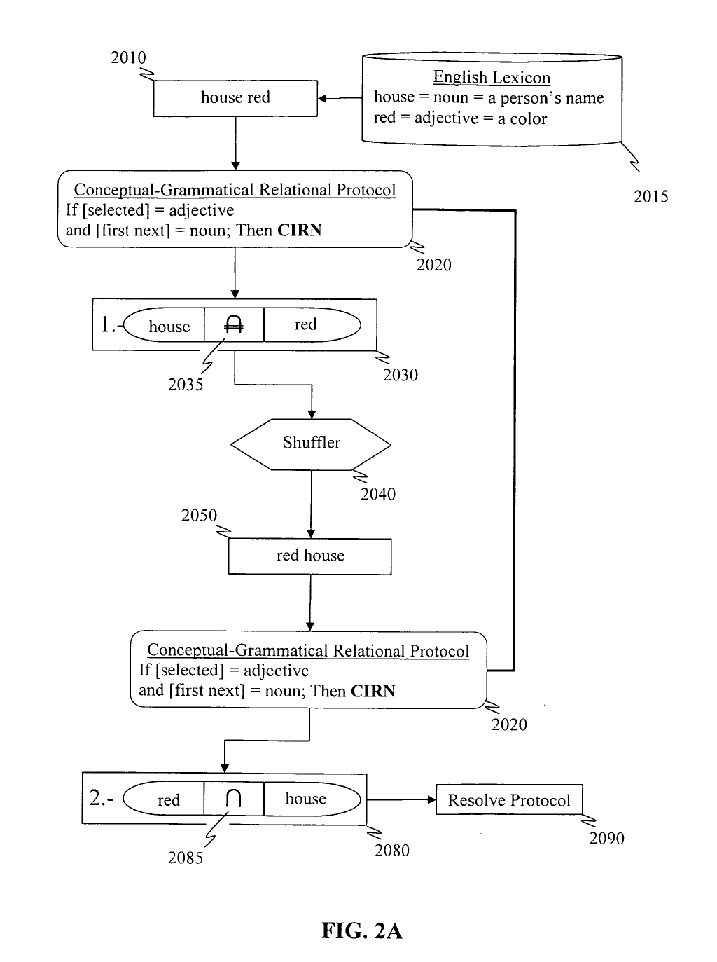

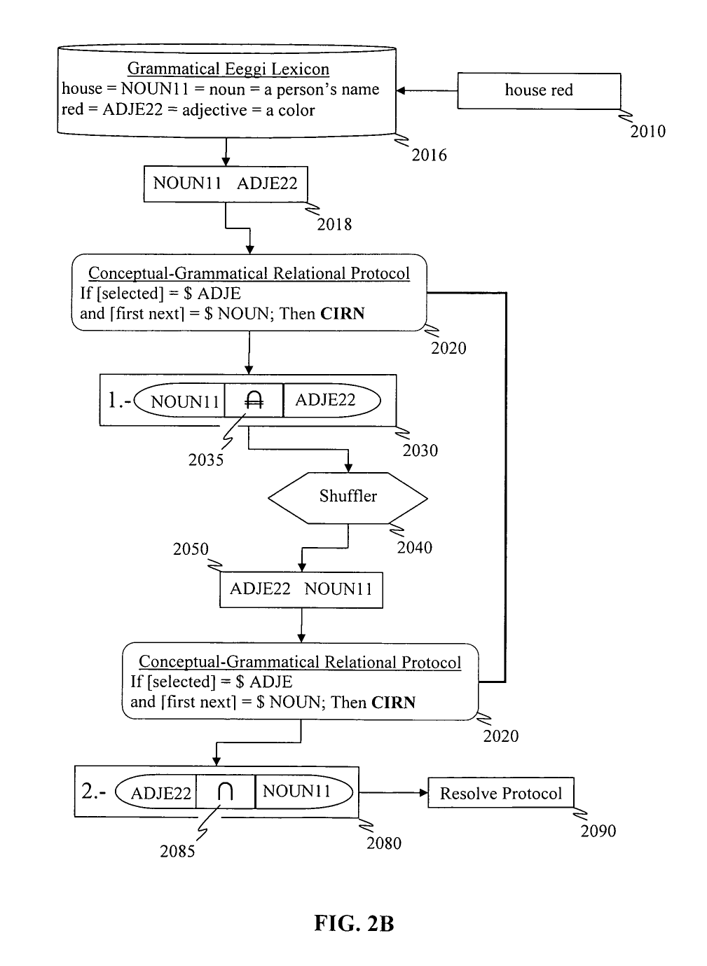

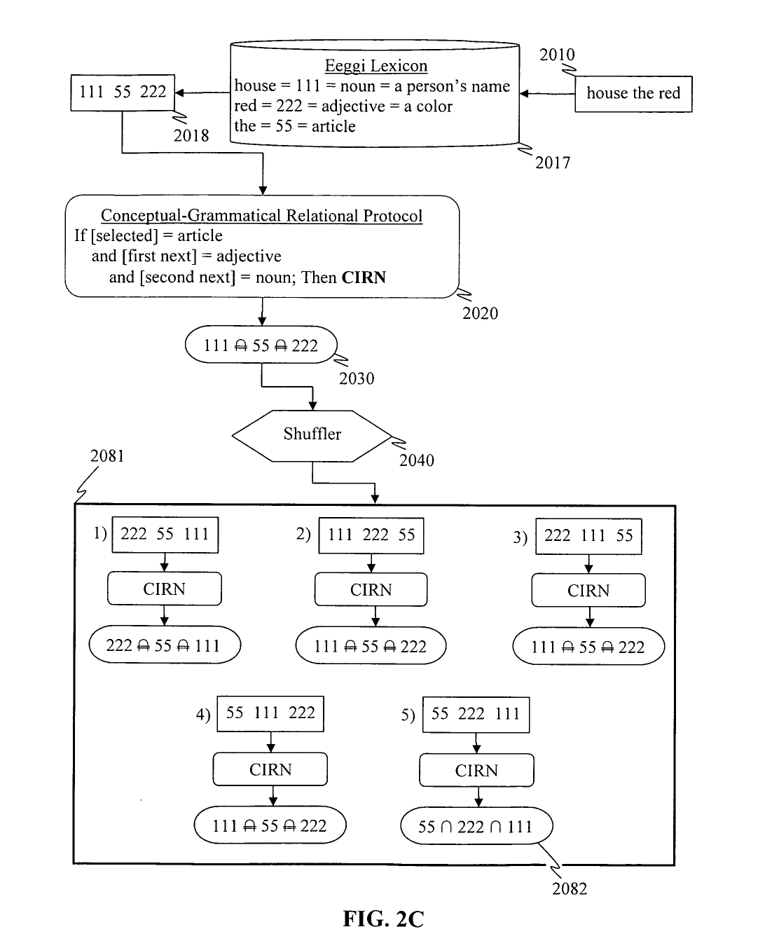

FIG. 2A is a non-limiting exemplary block diagram of the inventive method handling an exemplary Data Corpus such as “house red.” The Data Corpus 2010 (FIG. 2A) such as a query comprising the word elements “house red” is aid by a English Lexicon 2015 (FIG. 2A) for determining the grammatical classifications of the word elements for performing a Conceptual-Grammatical Relational Protocol 2020 (FIG. 2A) such as CIRN, with the objective of identifying at least one of a: association between word elements and identification of an association between the word elements. For example, the English Lexicon identifies that the word “house” is a noun and the word “red” is an adjective, thus providing information needed to perform the forthcoming analysis. As depicted the analysis comprises a set of conditional statements which must be true before an association is formed or is identified. The conditional statements (the analysis) basically states that if the selected word element happens to be an adjective (If [selected]=adjective), and the word element to its right happens to be a noun (and [first next]=noun), to then associate both (then CIRN). Accordingly, when “house red” is analyzed, it produces no association or an unsuccessful outcome. As a result, the Unsuccessful Outcome Table 2030 (FIG. 2A) is depicted comprising the word elements “house” and “red” forming no association as implied by the Failed Association Symbol 2035 (FIG. 2A). Next, in accordance to an unsuccessful outcome, the Shuffler 2040 (FIG. 2A) will alternate or shuffle the order of the word elements thus resulting in a new sequential order of elements as depicted in the Modified Data Corpus 2050 (FIG. 2A) or “red house.” Next, the CIRN (or alike) or a consequential type of CIRN analysis is applied on the Modified Data Corpus which in this instance comprises and/or fulfills all the conditional statements of the analyses, thus resulting in the Successful Outcome Table 2080 (FIG. 2A), which involves the word elements in an association as implied by the Affirmative Association Symbol 2085 (FIG. 2A). Also illustrated is the additional Resolve Protocol 2090 (FIG. 2A) which allows the system the option to communicate or interface the provider of the Data Corpus (or other). For example, the results from a successful outcome can be notified to a user in the form of a statement such as “Did you meant red house?” or simply proceed into performing a search implementing the Modified Data Corpus; while the results from failing to ever find a successful outcome generates a message such as “I am sorry, I did not understand your command. Consequentially the displayed results may not conceptually match your entry.”

FIG. 2B is a non-limiting exemplary block diagram of the inventive method handling an exemplary Data Corpus such as the spoken search command “house red” while implementing other word elements such as grammatical eeggi. The words of the Data Corpus 2010 (FIG. 2B) such as the query comprises several word elements such as “house red.” Next, the Grammatical Eeggi Lexicon 2016 (FIG. 2B) provides the information of every grammatical eeggi correspondent to every word of the Data Corpus. Noteworthy, a “grammatical eeggi” identifies the word and the word's grammatical classification such as implementing the characters “NOUN” for identifying all those words in a language which happen to be nouns. In such fashion, the word “house” in the Grammatical Eeggi Lexicon has a grammatical eeggi equal to “NOUN11,” wherein the characters “NOUN” identifies the eeggi (and the word) as a noun. Next, the said Data Corpus is converted to eeggi implementing the said Lexicon, thus resulting in the Eeggi Corpus 2018 (FIG. 2B). As illustrated, the Eeggi Corpus comprises the grammatical eeggis “NOUN11 ADJE22” in identical sequential order as their corresponding words. Next, the Eeggi Corpus is analyzed by the Conceptual-Grammatical Relational Protocol 2020 (FIG. 2B) such as CIRN. Noteworthy, a Conceptual-Grammatical Relational Protocol or analysis such as CIRN has the objective of identifying at least one of a: association between word elements and identification of an association between the word elements in accordance to a set of conditional rules (or others). For example, the conditional statements of the CIRN 2020 (FIG. 2B) state that if the selected grammatical eeggi element happens to be an adjective (If [selected]=$ ADJE), and the grammatical eeggi to its right happens to be a noun (and [first next]=$ NOUN; Then CIRN), to then associate both (adjective and noun). Accordingly, when “NOUN11 ADJE22” is analyzed, it produces no association or an unsuccessful outcome as depicted by the Unsuccessful Outcome Table 2030 (FIG. 2B) which depicts the eeggis “NOUN11” (house) and “ADJE22” (red) in a failed or unsuccessful relation as implied by the Failed Association Symbol 2035 (FIG. 2B). Next, in accordance to an unsuccessful outcome, the Shuffler 2040 (FIG. 2B) will alternate or shuffle the order of the grammatical eeggis, thus resulting in a new sequential order of eeggis as depicted in the Modified Eeggi Corpus 2050 (FIG. 2B) or “ADJE” (red) first and “NOUN11” (house) second. Next, the Modified Eeggi Corpus is analyzed again (CIRN or alike) which in this instance matches and/or fulfills all the conditional statements of the analyses. As a result, the Successful Outcome Table 2080 (FIG. 2B) comprises or depicts the grammatical eeggis forming an association as implied by the Affirmative Association Symbol 2085 (FIG. 2B). Also illustrated is the additional Resolve Protocol 2090 (FIG. 2B) which allows the system the option to communicate or interface the provider of the Data Corpus (or other entity) any results. For example, the results from a successful outcome can be notified to a user in the form of a statement such as “Did you meant red house?” or simply proceed into performing a search implementing the Modified Data Corpus; while the results from failing to ever achieve a successful outcome generates a message such as “I am sorry, I did not understand your command. Would you like to try again or would you prefer to continue?”

FIG. 2C is a non-limiting exemplary block diagram of the inventive method handling an exemplary Data Corpus such as “house the red” while implementing other word elements such as numeric spectrum identifier or eeggi. The words of the Data Corpus 2010 (FIG. 2C) such as a text entry comprises several word elements such as “house the red.” Next, the Eeggi Lexicon 2017 (FIG. 2C) provides the information of every eeggi correspondent to every word of the Data Corpus. Noteworthy, an eeggi is essentially an index identifying a word (optionally synonyms through its numeric range). In such fashion, according to the Eeggi Lexicon, a word such as “house” is a noun and has an eeggi of “111,” while another word such as “red” is an adjective and is identified by “222.” Next, the said Data Corpus is converted to eeggi implementing the said Lexicon, thus resulting in the Eeggi Corpus 2018 (FIG. 2C). As illustrated, the Eeggi Corpus comprises the word's corresponding eeggis “111 55 222” in identical sequential order. Next, the Eeggi Corpus is analyzed by the Conceptual-Grammatical Relational Protocol 2020 (FIG. 2C) such as CIRN. Noteworthy, a Conceptual-Grammatical Relational Protocol such as CIRN has the objective of identifying at least one of a: association between word elements and identification of an association between the word elements in accordance to a set of conditional rules (or others). For example, the conditional statements of the CIRN 2020 (FIG. 2C) states that if the selected eeggi happens to be an article (if [selected]=article), and the eeggi to its right happens to be an adjective (and [first next]=adjective), and the eeggi to the right of said adjective happens to be a noun (and [second next]=noun; Then CIRN), then CIRN. Accordingly, when “111 55 222” is analyzed, it produces no association or an unsuccessful outcome as depicted by the Unsuccessful Outcome 2030 (FIG. 2C) which depicts the eeggis “111” (house), “55” (the) and “222” (red) in a failed or unsuccessful association as implied and/or indicated by the “ [symbol] ” symbols. Next, in accordance to an unsuccessful outcome, the Shuffler 2040 (FIG. 2C) will alternate or shuffle the order of the eeggis, thus resulting in several sequential order of eeggis. The All Combinations Modified Eeggi Corpus 2081 (FIG. 2C) depicts 5 modified or shuffled corpuses of eeggis, which in this example were generated in a single event, that is, all possible combinations were accordingly created. Consequentially, each and every shuffled or modified corpus possible is illustrated with a corresponding analysis (CIRN or the alike) and its corresponding association outcome. For example, in said All Combinations Modified Eeggi Corpus, the first modification (222 55 111), second (111 222 55), third (222 111 55) and fourth (55 111 222) produce no associations. However, the fifth modified corpus or “55 222 111” has the precise sequential order that the CIRN 2020 (FIG. 2C) requires to fulfill an association. As a result, when applied, it results in a successful outcome or Fifth Outcome 2082 (FIG. 2C) which shows associations between the eeggis as implied the “∩” symbol. In such fashion, the disclosed methodology discovers a more suitable sequential order for the word elements, a sequential order which in fact makes grammatical and/or conceptual sense.

Noteworthy, FIGS. 2A, 2B and 2C illustrate by exemplary means some of the many variations available of word elements. In addition, there are also several types of languages, language directions, several ways to form associations, several types of Conceptual and/or Grammatical Relational Protocols (CIRN and the alike), several types of grammatical classifications (verb, noun, adverb, etc.), several possible types of abstract grammatical identification/classifications (semi-verbs, sub-adjectives, etc.) and their prospective combinations, among others, thus leading to possibly hundreds of other figures and corresponding detailed descriptions, which do not depart from the main spirit and scope of the disclosed inventive method.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method for identifying and/or discovering the best suited conceptual and/or grammatical sequential order of a non-conceptual-grammatical group of word elements can be appreciated. The described method overcomes the limitations encountered by current information technologies such as search engines, speech recognition, word processors, and others which fail to manipulate linguistic information in grammatical disarray, enabling them manipulate information in a more compelling, flexible and accurate way.

1. A Method for identifying and manipulating linguistic information comprising the steps of:
a) Identifying a First Data Corpus comprising a plurality of word elements, such as eeggi and words; wherein the word elements are in a first sequential order
b) Performing an analysis, such as CIRN, of the word elements; wherein said analysis includes at least one of a: successful outcome and unsuccessful outcome
c) Identifying an unsuccessful outcome of said analysis; wherein said unsuccessful outcome involves at least one of a: unsuccessful associations of the word elements and an identification of an unsuccessful association of the word elements
d) Modifying said sequential order of the word elements
e) Identifying a said Modified Data Corpus involving said modified sequential order of the word elements
f) Substituting the Data Corpus with said Modified Data Corpus until the Third Step identifies a successful outcome; wherein said successful outcome includes at least one of a: identification of an association between the word element, and an association between the word elements

2. A Method for identifying and manipulating linguistic information comprising the steps of:
a) Identifying a First Data Corpus comprising a plurality of word elements, such as eeggi and words; wherein the word elements are in a first sequential order
b) Performing an analysis, such as CIRN, of the word elements; wherein said analysis includes at least one of a: successful outcome and unsuccessful outcome
c) Identifying an unsuccessful outcome of said analysis; wherein said unsuccessful outcome involves at least one of a: unsuccessful associations of the word elements and an identification of an unsuccessful association of the word elements
d) Modifying said sequential order to form a plurality of sequential orders of said word elements,
e) Performing at least one analysis of said plurality of sequential orders of said word elements, wherein said analysis includes at least one of a: successful outcome and unsuccessful outcome
f) Identifying at least one successful outcome, wherein said successful outcome involves at least one of a: successful associations of the word elements and an identification of a successful association of the word elements
g) Identifying at least one sequential order associated to at least one said successful outcome.
